(19) United States
(12) Patent Application Publication
(10) Pub. No.: US 2024/0118675 A1
(43) Pub. Date: Apr. 11, 2024

(54) TECHNIQUES FOR ORTHODONTIC BRACKET PLACEMENT AND RELATED SYSTEMS AND METHODS

(71) Applicant: LightForce Orthodontics, Inc., Burlington, MA (US)

(72) Inventor: Alexander Yarmarkovich, Swampscott, MA (US)

(73) Assignee: LightForce Orthodontics, Inc., Burlington, MA (US)

(21) Appl. No.: 18/479,279

(22) Filed: Oct. 2, 2023

Related U.S. Application Data
(60) Provisional application No. 63/412,305, filed on Sep. 30, 2022.

(51) Int. Cl. G05B 19/4099; A61C 7/00; A61C 13/34; B33Y 50/02; B33Y 80/00

(52) U.S. Cl. CPC G05B 19/4099; A61C 7/002; A61C 13/34; B33Y 50/02; B33Y 80/00; A61C 7/14

(57) ABSTRACT

Techniques are described for determining bracket placement based on a cost function configured to reflect desired patient outcomes. By optimizing the cost function, positional parameters may be determined that define archwire and bracket placements that best reflect the desired outcomes. The brackets may then be arranged according to the determined positional parameters, and models for additive fabrication of the brackets may be generated. As a result, bracket placements that match desired patient outcomes may be more accurately and more efficiently determined.

### CROSS-REFERENCE TO RELATED APPLICATIONS

The present application claims the benefit under 35 U.S.C. § 119(e) of U.S. Provisional Patent Application No. 63/412,305, filed Sep. 30, 2022, titled “Techniques for Orthodontic Bracket Placement and Related Systems and Methods,” which is hereby incorporated by reference in its entirety.

### FIELD

The present application relates generally to placement of orthodontic brackets to produce a desired patient outcome.

### BACKGROUND

A misalignment of teeth, otherwise known as a malocclusion, can present medical challenges, including gum disease, tooth decay or loss, and long-term effects on the jaw. Malocclusions can also be aesthetically unpleasant and therefore undesirable for a patient. In some instances, a more aesthetic smile can enhance a patient's self-esteem and quality of life.

Edward Angle, who first classified various malocclusions, noted teeth should all fit on a line of occlusion, a smooth curve through the central fossae and cingulum of the upper canines, and through the buccal cusp and incisal edges of the mandible. Any deviations from this line of occlusion can result in malocclusions. The field of orthodontics involves the study and management of malocclusions, as well as misaligned bite patterns (e.g., overbites) and jaw arrangements.

Conventionally, orthodontic treatments involve orthodontic appliances such as braces, which apply static mechanical forces on the teeth to induce bone remodeling and facilitate alignment. Braces can include brackets adhered to the face of each tooth, connected to one another with archwires formed of resilient materials (e.g., nickel-titanium alloys). The archwires are adjusted throughout the orthodontic treatment to exert variable forces on the teeth and induce movement. The combination of the biomechanics of the mouth, as well as the orthodontic appliance can improve a patient's smile according to a treating clinician's orthodontic treatment plan.

### SUMMARY

According to some aspects, a computer-implemented method of arranging orthodontic brackets is provided, the method comprising using at least one processor obtaining one or more three-dimensional (3D) geometrical models for a plurality of teeth of a patient, obtaining one or more 3D geometrical models for a plurality of brackets to be arranged on respective teeth of the plurality of teeth, determining values for a plurality of positional parameters that optimize a master cost function, wherein the plurality of positional parameters are each indicative of a position of one or more of the plurality of brackets, and arranging the one or more 3D geometrical models of the plurality of brackets relative to the one or more 3D geometrical models for the plurality of teeth according to the determined values of the plurality of positional parameters.

According to some aspects, at least one non-transitory computer readable medium is provided comprising instructions that, when executed by at least one processor, perform a method comprising obtaining one or more three-dimensional (3D) geometrical models for a plurality of teeth of a patient, obtaining one or more 3D geometrical models for a plurality of brackets to be arranged on respective teeth of the plurality of teeth, determining values for a plurality of positional parameters that optimize a master cost function, wherein the plurality of positional parameters are each indicative of a position of one or more of the plurality of brackets, and arranging the one or more 3D geometrical models of the plurality of brackets relative to the one or more 3D geometrical models for the plurality of teeth according to the determined values of the plurality of positional parameters.

According to some aspects, a system is provided comprising at least one processor, and at least one non-transitory computer readable medium comprising instructions that, when executed by the at least one processor, perform a method comprising obtaining one or more three-dimensional (3D) geometrical models for a plurality of teeth of a patient, obtaining one or more 3D geometrical models for a plurality of brackets to be arranged on respective teeth of the plurality of teeth, determining values for a plurality of positional parameters that optimize a master cost function, wherein the plurality of positional parameters are each indicative of a position of one or more of the plurality of brackets, and arranging the one or more 3D geometrical models of the plurality of brackets relative to the one or more 3D geometrical models for the plurality of teeth according to the determined values of the plurality of positional parameters.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 shows a top view of teeth and bracket 3D models in an illustrative graphical user interface, according to some embodiments;

FIG. 2 is a flowchart of a method of determining bracket placement based on a cost function, according to some embodiments;

FIGS. 3A-3C depict illustrative positional parameters based on which a master cost function may be defined, according to some embodiments;

FIGS. 4A-4E depict examples of cost functions based on which a master cost function may be defined, according to some embodiments;

FIG. 5 is a block diagram of a system suitable for practicing aspects of the invention, according to some embodiments; and

FIG. 6 depicts a block diagram of an illustrative computing device which may be suitable for performing certain embodiments described herein.

### DETAILED DESCRIPTION

Orthodontics has been widely adapted in clinics to correct malocclusion and straighten teeth. The traditional method using braces employs preformed brackets adhered onto teeth, with elastic metal wires of round, square, or rectangular cross-sectional shape running through the bracket slots to provide the driving force. The adaptation of the bracket to the individual tooth is performed by filling the gap between the tooth surface and bracket surface with adhesive. This bonds the bracket to the tooth such that the bracket slot, when the teeth are moved to their final position, lies in a near flat (depending on manufacturing accuracy) horizontal plane.

Bracket positioning can require high levels of skill from the treating clinician. Once teeth movements are planned by a dental professional, the position of each bracket on a respective tooth is defined. Part of this process is to define the plane in which the archwire will be located after the teeth have moved, since the brackets should be aligned on or close to this plane. For instance, the dental professional may move 3D models of brackets relative to 3D models representing the patient's teeth. The dental professional may manually arrange the brackets on the teeth in this manner until the desired configuration of brackets is produced.

This process of manually adjusting bracket and archwire positions is time consuming and prone to errors, however. For instance, brackets may in some cases be placed too close to the teeth, leading to a bracket that would be too thin once fabricated, or too far away from the teeth, leading to a bracket that is too thick. While the dental professional may adjust the position of an individual bracket, this may affect the position of the archwire plane, and consequently may affect the positions of other brackets (e.g., which may now not lie along the archwire plane). To ensure brackets can be properly fabricated and placed on the teeth, therefore, requires a great deal of manual adjustment by the dental professional until an ideal placement of all the brackets has been found.

The inventors have recognized and appreciated techniques for determining bracket placement based on a cost function configured to reflect desired patient outcomes. By optimizing the cost function, positional parameters may be determined that define archwire and bracket placements that best reflect the desired outcomes. The brackets may then be arranged according to the determined positional parameters, and models for additive fabrication of the brackets may be generated. As a result, bracket placements that match desired patient outcomes may be more accurately and more efficiently determined.

According to some embodiments, the cost function (referred to hereafter as the “master cost function”) may be the sum of a plurality of cost functions, wherein each bracket has its own defined cost function. The cost function for a given bracket may be a function of one or more of the positional parameters. In some embodiments, the master cost function may further be a function of a cost function for an archwire plane, which is in turn a function of one or more of the positional parameters As a result, the master cost function may be a function of several positional parameters, some of which relate to the positioning of brackets and some of which relate to the positioning of the archwire plane. The positional parameters that relate to the brackets may relate to the position of the bracket relative to the tooth in a suitable coordinate system, for example, whereas the positional parameters that relate to the archwire plane may indicate the orientation of the plane (e.g., may include one or more angles).

In some embodiments, the master cost function is a non-linear function of the positional parameters, and determining the optimal values of the positional parameters comprises a non-linear squares analysis. For instance, optimizing the master cost function may comprise performing a Levenberg-Marquardt analysis.

According to some embodiments, positional parameters may include a facial-lingual offset for a bracket and/or a mesial-distal offset for a bracket. These parameters may be beneficial in defining the position of a bracket on a tooth relative to that tooth's coordinate system. The facial-lingual offset may, for example indicate the position of the bracket relative to the tooth surface (or some other nominal point along the facial-lingual axis of the tooth), whereas the mesial-distal offset may indicate the position of the bracket along the front surface of the tooth from side to side (e.g., relative to the tooth's facial axis (FA) point). Irrespective of the particular positional parameters utilized, the cost functions for each bracket may each be a function of any number of positional parameters, including one or more than one. For instance, the cost function for a bracket may be the sum of a first function defined in terms of the facial-lingual offset of the bracket and a second function defined in terms of the mesial-distal offset of the bracket.

Following below are more detailed descriptions of various concepts related to, and embodiments of, techniques for determining bracket placement based on a master cost function. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

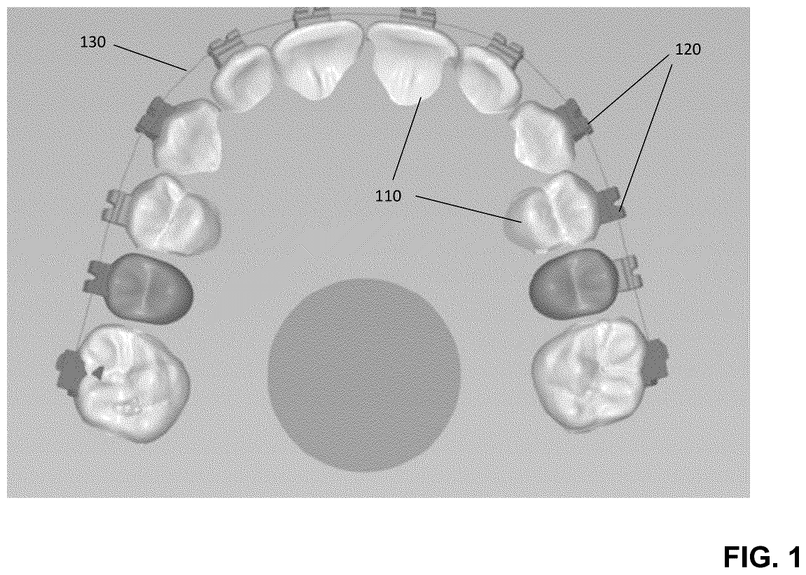

FIG. 1 shows a top view of teeth and bracket 3D models in an illustrative graphical user interface, according to some embodiments. To illustrate the above-described process in which a dental professional may manually adjust bracket positions, FIG. 1 shows an illustrative graphical user interface (GUI) that may allow a user to move the brackets 120 relative to the teeth 110 (e.g., by clicking and dragging a bracket). The 3D models of the teeth 110 may have been scanned from a patient, or may be otherwise based on scan data obtained from a patient. The archwire 130 may be manually adjusted by the user, or may be automatically placed based on the bracket placements.

As described above, adjusting the position of an individual bracket may affect the position of the archwire plane, and consequently may affect the positions of other brackets (e.g., which may now not lie along the archwire plane). The brackets are ideally placed at or near to the facial axis (FA) point of each tooth, and ideally have a thickness within a desired range, but arranging all the brackets on the patient's tooth anatomy while also ensuring that the brackets all share the same archwire plane may be very difficult, leading to the aforementioned long process of adjustment by a dental professional.

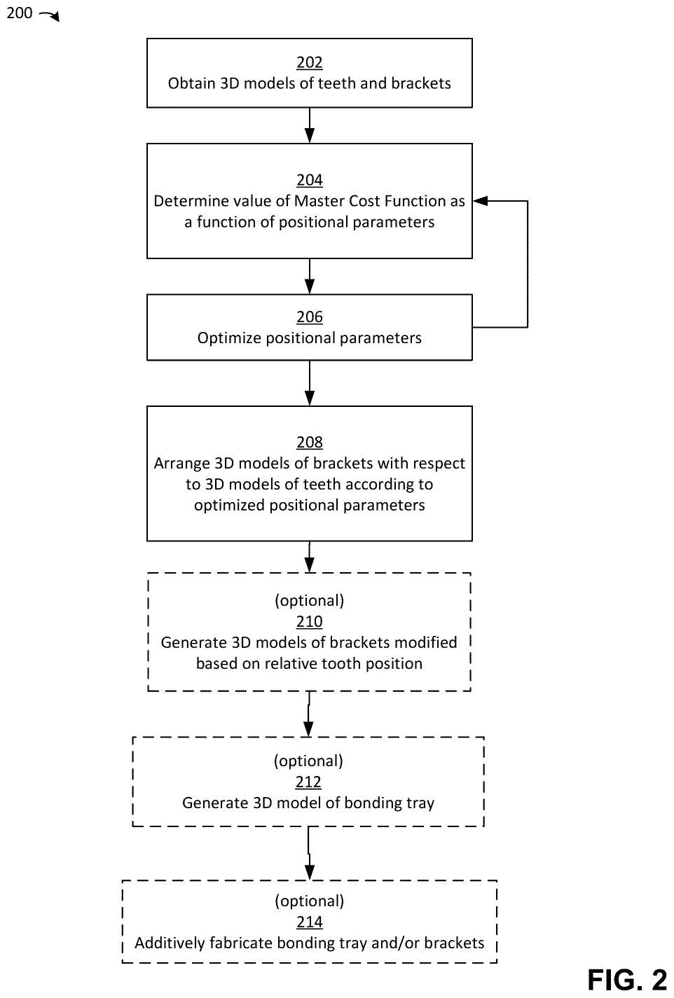

FIG. 2 is a flowchart of a method of determining bracket placement based on a cost function, according to some embodiments. Method 200 may be performed by a suitable computing system, examples of which are described below. Method 200 may be initiated in response to user input provided to the computing system, such as the user interacting with a suitable control in a graphical user interface (e.g., by clicking on an “optimize bracket placement” button).

In act 202, one or more 3D models representing the teeth of a patient, and one or more 3D models of brackets, are obtained. A “3D model” (or simply “model”) as referred to herein may include any data describing a three-dimensional structure or structures, irrespective of file format or number of data files.

According to some embodiments, the 3D model(s) of the patient's teeth obtained in act 202 may have been generated using a suitable optical scanner operated by a dental professional by capturing images of the patient's teeth, or may be otherwise generated based on data obtained from a scan of the teeth. The patient's teeth may be represented in method 200 by any number of 3D models, including, but not limited to, as individual 3D models for each tooth. Prior to method 200, the 3D models of the teeth may be arranged relative to one another (at least within a single arch) by a dental professional according to a treatment plan (e.g., in a desired ‘final’ configuration as a result of the orthodontic treatment).

According to some embodiments, the 3D models(s) of brackets obtained in act 202 may be identical, or may include different bracket models. For example, brackets for molar teeth may all utilize the same 3D model, whereas brackets for the incisors or canines may utilize a different 3D model. The 3D model(s) for the brackets may be pre-generated for particular dental needs and may be selected from a library of suitable models in act 202. In some embodiments, act 202 may comprise selection, by a user, of one or more 3D models of brackets from a graphical user interface. For example, the graphical user interface may present a perspective view of a 3D model of at least some of the patient's teeth and allow a user to add a 3D model of a desired brackets from a list of available brackets models, to the view showing the model of the teeth.

In act 204, a value for a master cost function is determined based on the 3D models for the teeth and the brackets. As described above, the master cost function may be a function of one or more positional parameters, which describe the placement of the brackets relative to the teeth. An initial value for the master cost function may be calculated assuming initial values for these positional parameters. According to some embodiments, the initial values for the positional parameters may be identified by initial positions of the brackets defined by a user. For instance, the user may provide initial placements of the brackets through the graphical user interface shown in FIG. 1, and initial values of the positional parameters may be determined based on these placements. According to some embodiments, the initial values for the positional parameters may be selected assuming some nominal position of the brackets relative to the tooth, such as by starting with the brackets all at the FA points of their respective teeth and with a nominal offset from the surface.

According to some embodiments, the master cost function MCF may be written as follows:

$$M C F = {\sum }_{b = 1}^{B} {\sum }_{n = 1}^{N} {{ω}_{n} ( C {F}_{n} )}^{2} ( {P}_{b}^{i} ) \qquad ( Eqn . 1 )$$

This master cost function is defined for B brackets, with N different cost functions CF being defined for each of the brackets, and the cost functions CF each being a function of any one or more of the positional parameters Pⁱ and have corresponding weights ωₙ. In some cases, the master cost function MCF may be a function of at least one cost function CF that is dependent on positional parameters relating to multiple different brackets.

As an example use case of Equation 1, in the case of three brackets with cost functions CF₁ and CF₂ utilized for each bracket and with two positional parameters x_{b} and y_{b} indicating the position of each bracket b:

MCF=ω₁CF₁²(x₁,y₁)+ω₂CF₂²(x₁,y₁)+ω₁CF₁²(x₂,y₂)+ω₂CF₂²(x₂,y₂)+ω₁CF₂²(x₃,y₃)+ω₂CF₂²(x₃,y₃)

The weight values co n may be selected to allow different cost functions CF to contribute different amounts to the master cost function (e.g., if one cost function is believed to be comparatively more important than another cost function, it may be assigned a comparatively higher value).

According to some embodiments, the master cost function may be a function of positional parameters that include a facial-lingual offset for a bracket and a mesial-distal offset for a bracket. Additionally, or alternatively, the master cost function may be a function of positional parameters that include angles of an archwire plane (e.g., three angles defining a three-dimensional orientation). For example, for a single arch, the master cost function may be defined in terms of one or more cost functions for each bracket that are a function of both the facial-lingual offset and mesial-distal offset for a total of 28 parameters (2 parameters for each of 14 teeth) and further in terms of one or more cost functions for the archwire plane that are a function of three angle parameters, for a total of 31 parameters. Optimizing such a master cost function as described below may therefore comprise determining the values of these 31 parameters that optimize (e.g., minimize) the master cost function.

In some embodiments, positional parameters describing the positions of brackets for both arches may be optimized with the same process. For example, in the above example, the master cost function may be defined in terms of one or more cost functions for each bracket that are a function of both the facial-lingual offset and mesial-distal offset for a total of 56 parameters (2 parameters for each of 28 teeth) and further in terms of one or more cost functions for each archwire plane that are each a function of three angle parameters, for a total of 62 parameters. Alternatively, method 200 may be performed for each of the upper and lower brackets independently.

According to some embodiments, the master cost function may be optimized while enforcing a condition that the brackets are placed along the archwire plane. As described above, the archwire position and/or orientation may be defined via one or more positional parameters that are themselves varied during optimization. A requirement that the brackets are placed along the archwire plane thereby limits allowed values of the positional parameters for each bracket to some extent. In some embodiments, the master cost function may not be defined as a function of the positional parameters that describe the position and/or orientation of the archwire; however these positional parameters may also be optimized along with the remaining positional parameters during the optimization process, since values of these positional parameters indirectly affect the values of the positional parameters that define the positions of brackets. In some embodiments, the requirement that the brackets are placed along the archwire plane may allow for some small range of motion of the brackets relative to the archwire, since brackets do not necessarily have to be placed at a precise location relative to the archwire. In other words, the requirement that the brackets are placed along the archwire plane may amount to a requirement that the brackets are placed within a certain distance of the archwire plane.

Irrespective of how the master cost function is defined, in act 206 an optimization of the positional parameters is performed. Repeating acts 204 and 206 may be performed as part of an optimization process in which the master cost function is repeatedly calculated for different values of the positional parameters to find the values of the positional parameters that optimize (e.g., minimize or maximize) the master cost function. In some embodiments, the optimization process may comprise a least squares analysis, such as a non-linear least squares analysis. As shown above the master cost function may be defined in terms of a sum of squares of different cost functions, such that an analysis such as Levenberg-Marquardt may be particularly appropriate. However, the master cost function may be defined in some other way and some other optimization process may instead be applied in method 200.

Once the values of the positional parameters that optimize the master cost function have been determined, in act 208 the 3D models of the brackets may be arranged with respect to the 3D model(s) of the teeth according to (or otherwise based on) the optimized values of the positional parameters. In some embodiments, act 208 may comprise determining 3D coordinate positions for each of the brackets within a 3D space in which the 3D models of the teeth are arranged.

According to some embodiments, act 208 comprises identifying a point on the archwire plane for one or more of the brackets, according to the optimized values of the positional parameters. A shape for the archwire is then determined by generating a smooth curve that passes through (or near to) each of these points. For example, the curve may be generated as a non-uniform rational B-spline (NURBS) curve using the identified points as control points. Any one or more of the brackets may then be positioned along the generated curve. In some embodiments, points may be identified for the anterior teeth (the front six teeth on a given arch) and the rearmost teeth, and used to generate a smooth curve, such as a NURB spline. The brackets for the remaining teeth may then be placed on the generated curve. Such a curve may be referred to herein as an archwire path.

In some embodiments, act 208 may comprise performing one or more coordinate transformations between a coordinate frame in which the positional parameters are defined and a common coordinate frame in which the 3D models of the teeth are arranged. For example, if the positional parameter(s) for each bracket relate the bracket's position to a reference point on the corresponding tooth, a transformation may be performed between the coordinate frame of that tooth and the coordinate frame in which all the teeth and brackets are being arranged, to determine the proper placement of the bracket.

In some embodiments, act 208 may comprise presenting the 3D models of the brackets in their determined positions via a graphical user interface. A user may thereby visually see the determined positions of the brackets subsequent to optimization of the positional parameters. As described above, a user may, prior to execution of method 200 or otherwise, initiate the optimization process by interacting with a suitable control in a graphical user interface. The same graphical user interface may then, in some embodiments, update the visual positions of the brackets so the user is able to see the modified positions of the brackets.

Method 200 may end with act 208, or may optionally include any one or more of acts 210, 212 and 214 as shown in FIG. 2 and described below. In act 210, a 3D model for each bracket may be generated based on the determined positions of the brackets relative to the 3D models of the teeth. For instance, the surface of intersection between a bracket and the associated tooth may be different for each bracket due to the placement of the bracket and the tooth anatomy. This may be the case even where each of the bracket models are nominally the same. As a result, to fabricate the brackets, the shape of the portion of the bracket model that is arranged exterior to the tooth may be determined. For instance, a Boolean subtraction operation may be performed on one or more bracket models when they are arranged in the determined locations relative to the teeth to produce bracket models that have surfaces that match those of the teeth. The resulting modified bracket models may therefore be suitable for fabrication for the patient.

In act 212, a 3D model of an indirect bonding tray may be generated based on the determined positions of each bracket on each tooth and based on one or more 3D models representing a current configuration of the patient's teeth. An indirect bonding tray (hereinafter “bonding tray”) may be used to deliver brackets to desired locations on the patient's teeth during installation of the brackets. For example, brackets may be fabricated an inserted into recesses in the bonding tray, and cement may be applied to the surfaces of the brackets. The bonding tray is configured to match the arch and teeth anatomy of the patient so that by placing the tray against the teeth and arch, the brackets will be aligned in the desired locations on each tooth.

In some embodiments, act 212 may comprise generating a 3D model of an bonding tray based on a 3D model of the patient's arch, one or more 3D models representing the patient's teeth (in their present configuration), and the 3D models of the brackets in positions determined according to the optimized positional parameters. In some embodiments, act 212 includes subtracting the 3D models of the arch, teeth, and bracket models from an initial 3D volume. The 3D models may be first arranged in a virtual space so that that have a relative position and orientation to one another that matches the patient's anatomy.

According to some embodiments, the 3D model of the bonding tray may be generated in act 212 by obtaining a 3D model representing a generic bonding tray, aligning this model with the teeth, arch, and brackets, and performing a geometric subtraction (e.g., Boolean subtraction) of the teeth, arch and brackets from the 3D model of the generic bonding tray to produce a 3D model of a bonding tray that has regions carved out into which the teeth, brackets, and/or arch may fit. It should be appreciated that the 3D model of the bonding tray can be generated in one or more steps. For example, a single subtraction step and/or multiple subtraction steps can be performed for the teeth, arch, and bracket 3D models. Moreover, the bonding tray model may be generated based on the modified 3D models generated in act 210 or may be generated based on the bracket models utilized for initial alignment prior to optimization of the positional parameters.

According to some embodiments, the 3D model of the bonding tray may be generated in act 212 by determining an offset from desired surfaces of the teeth and arch to which the bonding tray will contact and forming this into a three-dimensional shell around those surfaces.

In some embodiments, some or all of the 3D model of the bonding tray may be scaled, or offset from the teeth or arch, to add a desired tolerance gap between the bonding tray and the teeth and/or arch. In some embodiments, an expected dimensional change during additive fabrication may be considered and used to scale the model larger or smaller. For instance, if the additive fabrication process is known to produce parts that shrink by a certain percentage, the model may be scaled larger by this percentage to offset the expected shrinkage. In some embodiments, both a tolerance gap and expected shrinkage may be taken into account when scaling the generated 3D model of the bonding tray.

In act 214, instructions are generated for an additive fabrication device that, when executed by the additive fabrication device, will fabricate the customized bonding tray according to the 3D model of the customized bonding tray generated in act 212 and/or will fabricate the brackets according to the 3D models of the modified brackets generated in act 210. In some embodiments, an additive fabrication device may be configured to fabricate the customized bonding tray from a biocompatible polymer, such as a photopolymer resin. For instance, the additive fabrication device may be a stereolithographic or DLP device. In some embodiments, an additive fabrication device may be configured to fabricate the brackets using a ceramic slurry-based additive fabrication technology, examples of which may include digital light processing (DLP), laser photopolymerization stereolithography, jet printing (including particle jetting, nanoparticle jetting), layer slurry deposition (LSD), or laser-induced slip casting.

In some embodiments, the additive fabrication devices for which instructions are generated in act 214 may be a single device configured to fabricate parts from different materials, or may be different devices configured to fabricate parts from different materials. For example, instructions may be generated in act 214 for a first additive fabrication device that, when executed by the first additive fabrication device, fabricates the bonding tray from a first material (e.g., a polymer), and instructions may further be generated in act 214 for a second additive fabrication device that, when executed by the second additive fabrication device, fabricates one or more of the brackets from a second material (e.g., a ceramic).

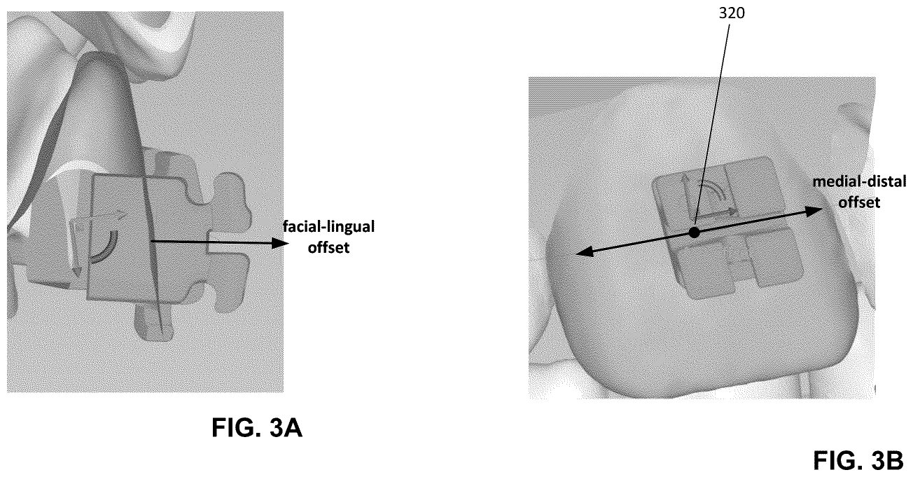

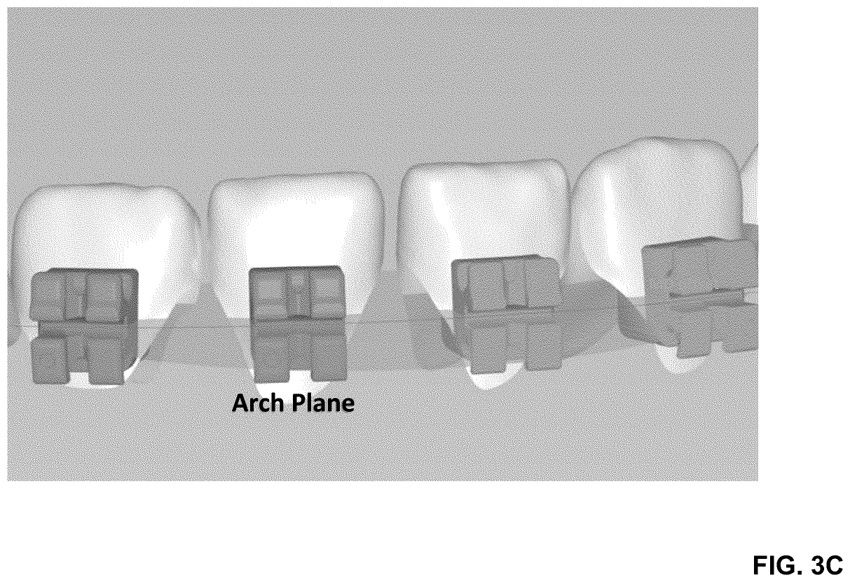

FIGS. 3A-3C depict illustrative positional parameters based on which a master cost function may be defined, according to some embodiments. As described above, illustrative positional parameters may include a facial-lingual offset, which is depicted in FIG. 3A. According to some embodiments, the facial-lingual offset may be defined as the distance from the center of the bracket slot to the tooth surface along a direction normal to the slot. Positional parameters may also, in some embodiments, include a mesial-distal offset, depicted in FIG. 3B. According to some embodiments, the mesial-distal offset may be defined as an offset along the mesial or distal directions relative to the FA point 320, so that the mesial-distal offset of zero corresponds to a bracket centered at the FA point.

Positional parameters may also, in some embodiments, include one or more parameters indicating an orientation and/or position of the archwire plane, depicted in FIG. 3C. As described above, the brackets preferably are aligned so that their centers pass through a common archwire plane.

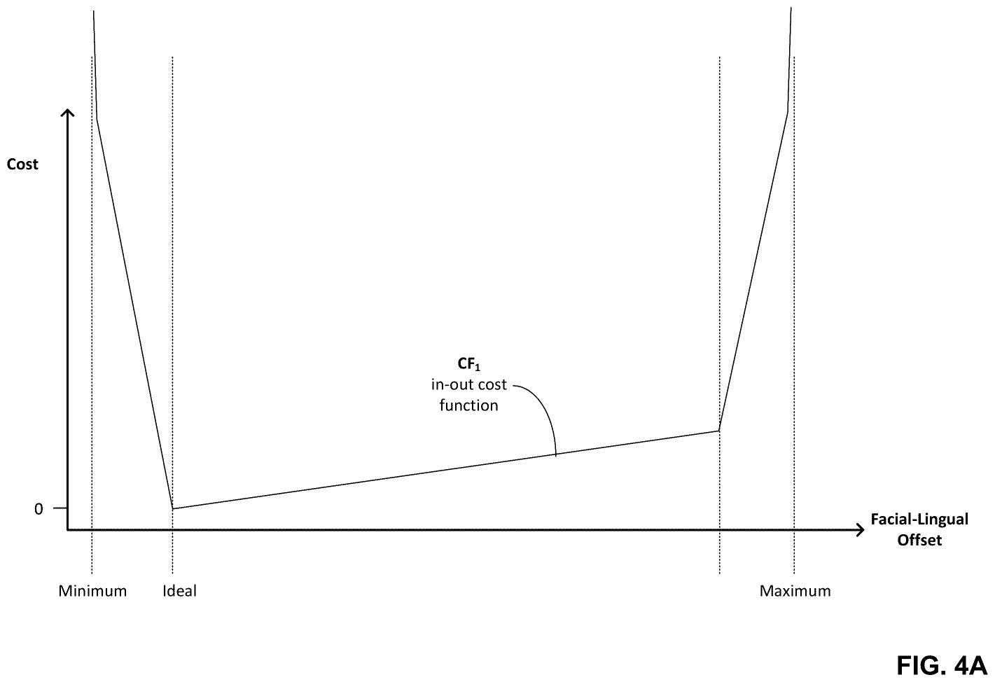

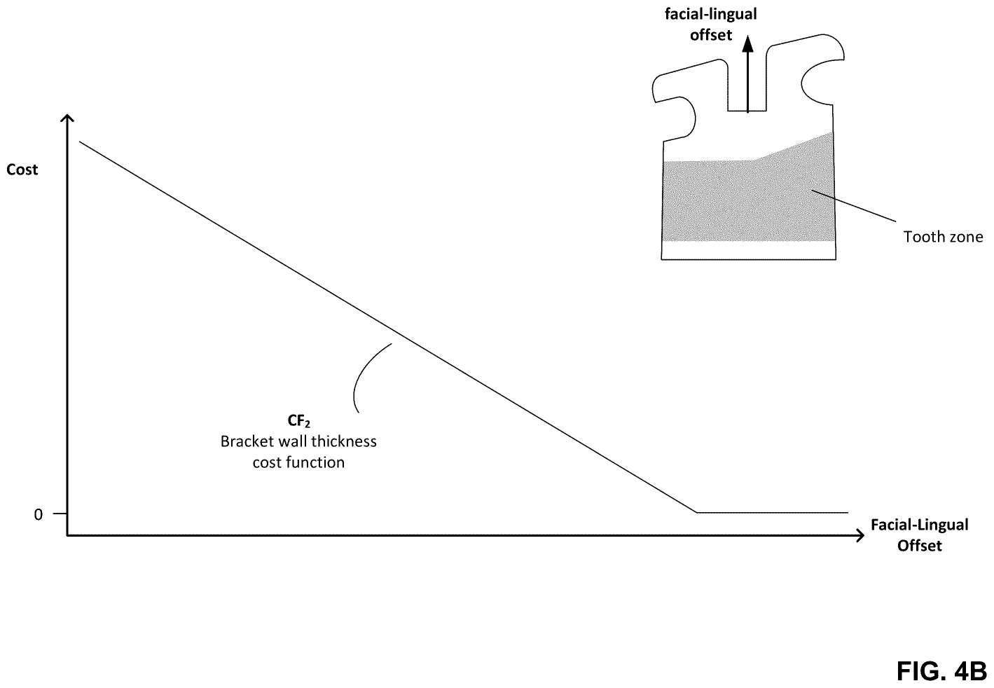

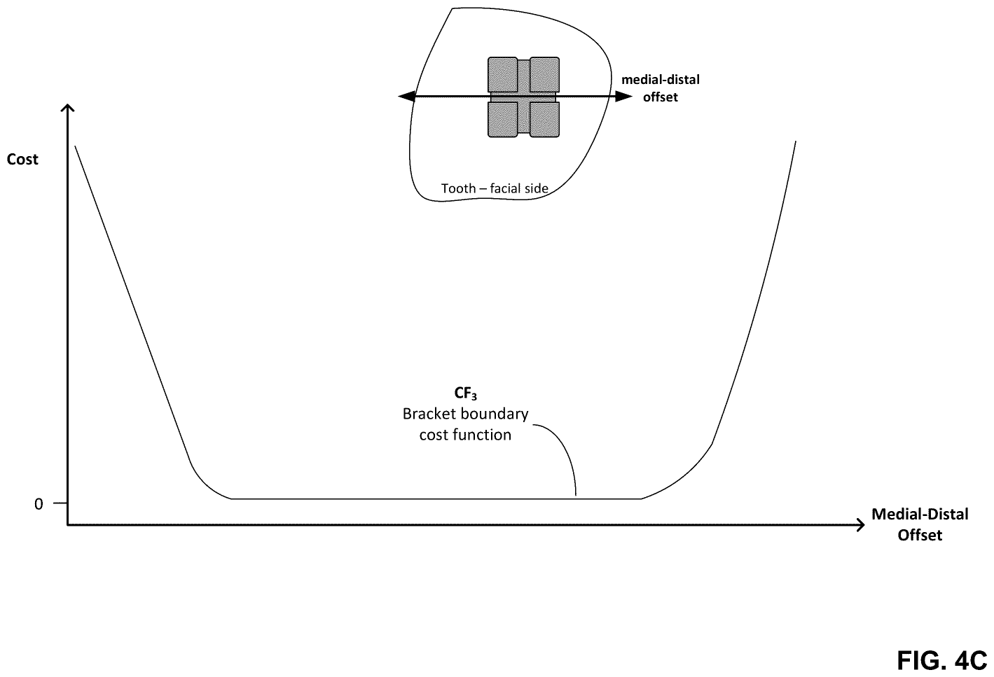

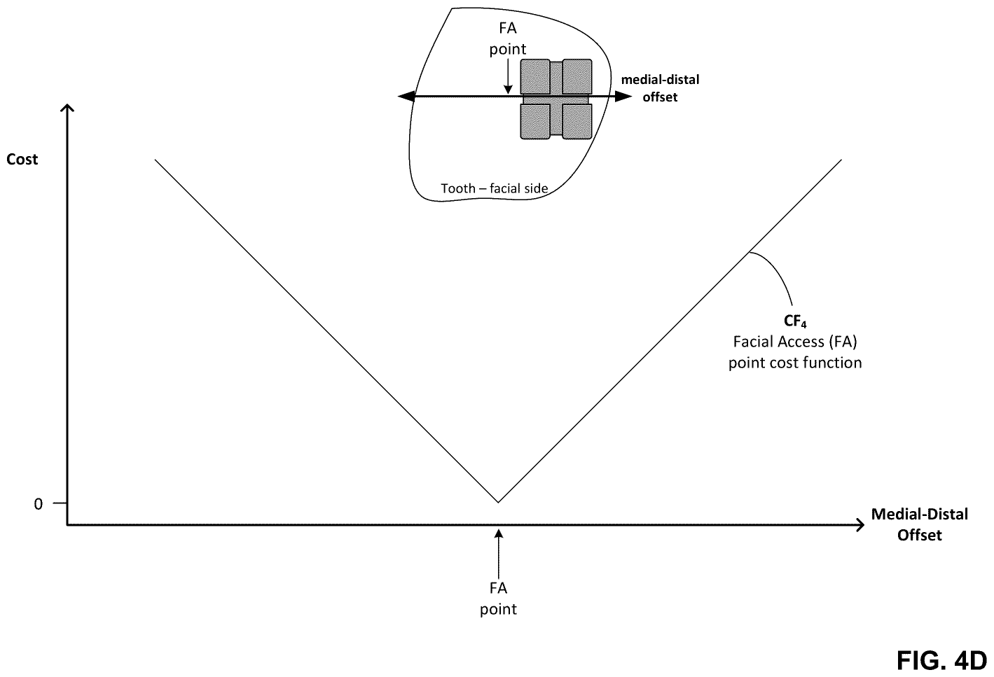

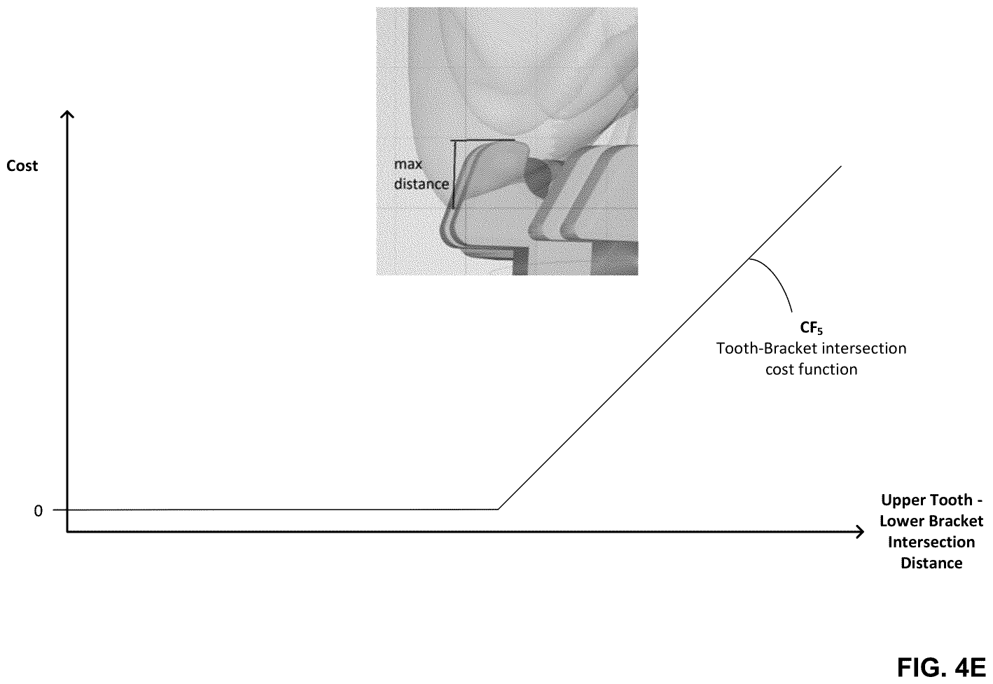

FIGS. 4A-4E depict examples of cost functions CF based on which a master cost function MCF as given by Equation 1 above may be defined, according to some embodiments. In the examples of FIGS. 4A-4E, the illustrative cost functions are a function of the facial-lingual offset (in the examples of FIGS. 4A-4B), the mesial-distal offset (in the examples of FIGS. 4C-4D), or an intersection distance between an upper tooth and a lower bracket (in the example of FIG. 4E). It will be appreciated that these illustrative cost functions are provided merely as examples, and that MCF may be defined using any number of cost functions CF, each of which may be a function of any number and type of positional parameters, as the techniques described herein are not limited to any particular positional parameters or cost functions.

FIG. 4A depicts an example of a cost function CF₁, according to some embodiments. The cost function CF₁ enforces a rule that the bracket is ideally arranged at a particular position along the facial-lingual direction. As shown, the function increases dramatically when the facial-lingual offset is either below some minimum value or above some minimum value, but is zero when the facial-lingual offset is at the preferred, ‘ideal’ value.

FIG. 4B depicts an example of a cost function CF₂, according to some embodiments. The cost function CF₂ enforces a rule that the wall thickness of the bracket is above a desired amount to avoid producing a bracket that is too thin. As shown, the cost is zero when the facial-lingual offset is above some threshold value, and increases with distance as the bracket moves in the lingual direction. The effect of this cost function is shown in the inset drawing, which shows that if the bracket were placed too close to the tooth in the facial-lingual direction, the bracket may be too thin.

FIG. 4C depicts an example of a cost function CF₃, according to some embodiments. The cost function CF₃ enforces a rule that the bracket is preferentially arranged completely on the tooth. That is, the boundary of the bracket is preferentially within the tooth shape as viewed from the facial direction. In the illustrative example shown in FIG. 4C, the cost of function CF₃ is defined as an amount of the bracket that is visible from the back side of the facial surface of the tooth as a function of the medial-distal offset.

FIG. 4D depicts an example of a cost function CF₄, according to some embodiments. The cost function CF₄ enforces a rule that the bracket is preferentially arranged at the FA point. As such, the cost of the function is zero when the bracket is at the FA point, and increases with medial-distal offset as the bracket moves away from the FA point in either the medial or distal direction.

FIG. 4E depicts an example of a cost function CF₅, according to some embodiments. The cost function CF s enforces a rule that a lower bracket preferentially does not intersect with the corresponding tooth of the upper arch. The cost of the function is zero when there is no intersection between the lower bracket and the upper tooth, and increases with intersection distance (e.g., greatest distance of intersection). In some embodiments, the cost function CF₅ may be evaluated, at least in part, by determining the extent to which a 3D model of a lower bracket in a given position overlaps with a 3D model of an upper tooth. For example, models obtained in act 202 of method 200 may be evaluated during optimization based on values of other positional parameters for the bracket. In some embodiments, the cost function CF s may be evaluated by arranging 3D models of the patient's teeth into a closed jaw/teeth arrangement to simulate possible impingement of the bracket and teeth when the patient's closes their jaw.

According to some embodiments, illustrative weights ωₙ for the five cost functions described above may, within the context of Equation 1 above, be defined as follows: ω₁=0.5; ω₂=2000; ω₃=1; ω₄=0.7; and ω₅=1000.

As described above, while the archwire plane may not necessarily be defined as a cost function that contributes to the value of the master cost function, positional parameters that describe the archwire plane position and/or orientation may be optimized while enforcing a condition that the brackets can be placed only on (or close to) the archwire plane during optimization. Additionally, or alternatively, the master cost function could be defined as a function of a suitable cost function for the archwire plane position and/or orientation.

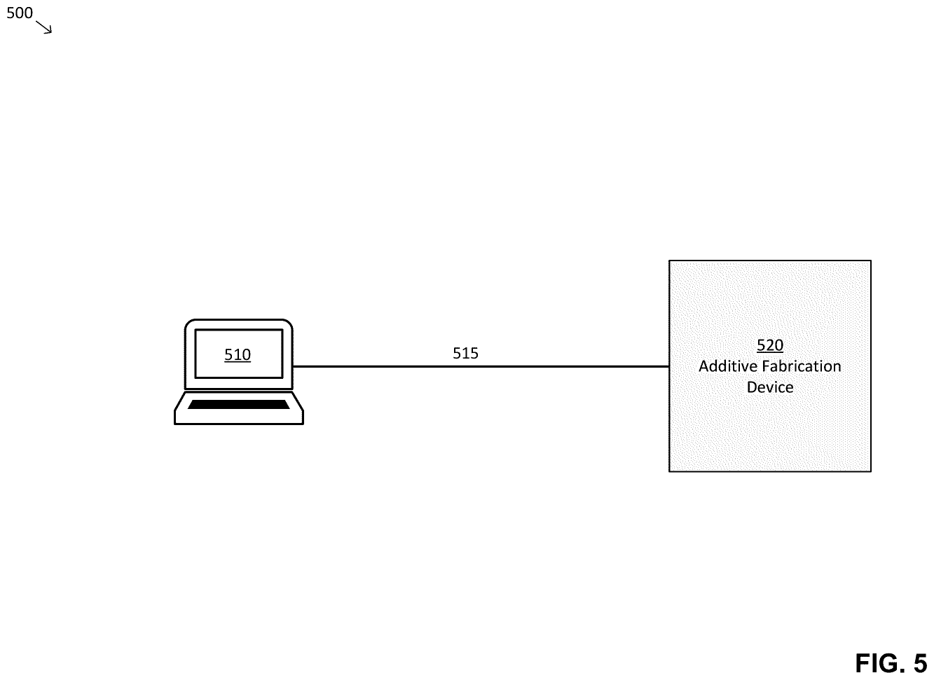

FIG. 5 is a block diagram of a system suitable for practicing aspects of the invention, according to some embodiments. System 500 illustrates a system suitable for generating instructions to perform additive fabrication by an additive fabrication device and subsequent operation of the additive fabrication device to fabricate a part. For instance, instructions to fabricate one or more brackets as described above may be generated by the system and provided to the additive fabrication device. Various parameters associated with fabrication of brackets may be stored by computer system 510 and accessed when generating instructions for the additive fabrication device 520.

According to some embodiments, computer system 510 may execute software that generates instructions for fabricating a part using an additive fabrication device. Said instructions may then be provided to an additive fabrication device, such as additive fabrication device 520, via link 515, which may comprise any suitable wired and/or wireless communications connection. In some embodiments, a single housing holds the computer system 510 and additive fabrication device 520 such that the link 515 is an internal link connecting two modules within the housing of system 500.

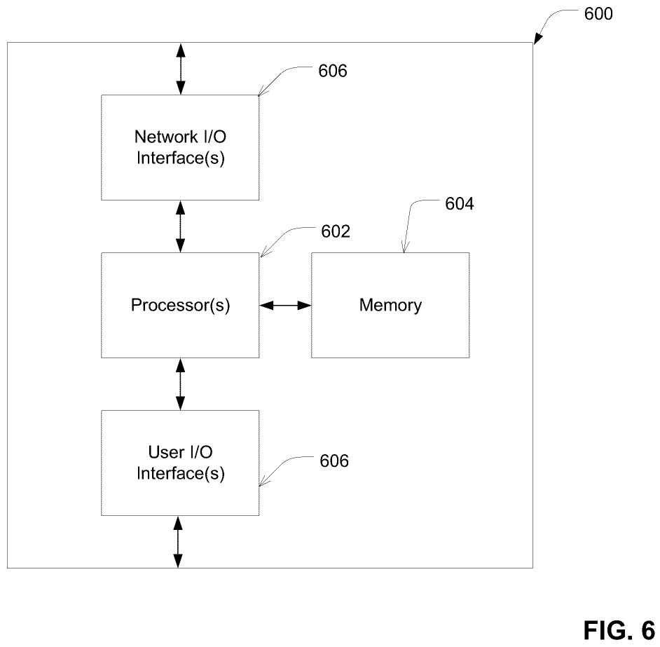

In some embodiments, systems and techniques described herein may be implemented using one or more computing devices. In particular, a computing device may be operated to perform method 200, including optimization of positional parameters, as described above. Embodiments are not, however, limited to operating with any particular type of computing device. By way of further illustration, FIG. 6 is a block diagram of an illustrative computing device 600. Computing device 600 may include one or more processors 602 and one or more tangible, non-transitory computer-readable storage media (e.g., memory 604). Memory 604 may store, in a tangible non-transitory computer-recordable medium, computer program instructions that, when executed, implement any of the above-described functionality. Processor(s) 602 may be coupled to memory 604 and may execute such computer program instructions to cause the functionality to be realized and performed.

Computing device 600 may also include a network input/output (I/O) interface 606 via which the computing device may communicate with other computing devices (e.g., over a network), and may also include one or more user I/O interfaces 606, via which the computing device may provide output to and receive input from a user. The user I/O interfaces may include devices such as a keyboard, a mouse, a microphone, a display device (e.g., a monitor or touch screen), speakers, a camera, and/or various other types of I/O devices.

The above-described embodiments can be implemented in any of numerous ways. As an example, the embodiments may be implemented using hardware, software or a combination thereof. When implemented in software, the software code can be executed on any suitable processor (e.g., a microprocessor) or collection of processors, whether provided in a single computing device or distributed among multiple computing devices. It should be appreciated that any component or collection of components that perform the functions described above can be generically considered as one or more controllers that control the above-described functions. The one or more controllers can be implemented in numerous ways, such as with dedicated hardware, or with general purpose hardware (e.g., one or more processors) that is programmed using microcode or software to perform the functions recited above.

In some embodiments, a software-based application may be connected (e.g., via a wired or wireless connection) to one or more components of a computing device. In certain embodiments, for example, the computing device 600 may be controlled, at least in part, by a software-based application. In some cases, a user may operate a graphical user interface to perform one or more acts of method 200 through the software-based application. In some cases, the software-based application may store information (e.g., initial bracket positions) generated based on user input.

In this respect, it should be appreciated that one implementation of the embodiments described herein comprises at least one computer-readable storage medium (e.g., RAM, ROM, EEPROM, flash memory or other memory technology, CD-ROM, digital versatile disks (DVD) or other optical disk storage, magnetic cassettes, magnetic tape, magnetic disk storage or other magnetic storage devices, or other tangible, non-transitory computer-readable storage medium) encoded with a computer program (i.e., a plurality of executable instructions) that, when executed on one or more processors, performs the above-described functions of one or more embodiments. The computer-readable medium may be transportable such that the program stored thereon can be loaded onto any computing device to implement aspects of the techniques described herein. In addition, it should be appreciated that the reference to a computer program which, when executed, performs any of the above-described functions, is not limited to an application program running on a host computer. Rather, the terms computer program and software are used herein in a generic sense to reference any type of computer code (e.g., application software, firmware, microcode, or any other form of computer instruction) that can be employed to program one or more processors to implement aspects of the techniques described herein.

Having thus described several aspects of at least one embodiment of this invention, it is to be appreciated that various alterations, modifications, and improvements will readily occur to those skilled in the art. The aspects include, but are not limited to, the following aspects:

1. A computer-implemented method of arranging orthodontic brackets, the method comprising: using at least one processor: obtaining one or more three-dimensional (3D) geometrical models for a plurality of teeth of a patient; obtaining one or more 3D geometrical models for a plurality of brackets to be arranged on respective teeth of the plurality of teeth; determining values for a plurality of positional parameters that optimize a master cost function, wherein the plurality of positional parameters are each indicative of a position of one or more of the plurality of brackets; and arranging the one or more 3D geometrical models of the plurality of brackets relative to the one or more 3D geometrical models for the plurality of teeth according to the determined values of the plurality of positional parameters.

2. The method of aspect 1, wherein the master cost function is a function of one or more bracket cost functions for each of the plurality of brackets; and the one or more bracket cost functions for a respective bracket of the plurality of brackets are each a function of one or more of the plurality of positional parameters.

3. The method of aspect 2, wherein the one or more bracket cost functions for the respective bracket comprise one or more of: an in-out cost function that is a function of the respective bracket's facial-lingual position; a bracket wall thickness cost function that is a function of the respective bracket's facial-lingual position; a bracket boundary cost function that is a function of the respective bracket's mesial-distal position; and a facial axis (FA) point cost function that is a function of the respective bracket's mesial-distal position.

4. The method of aspect 2, wherein the one or more bracket cost functions for the respective bracket comprise an upper teeth and lower bracket intersection cost function.

5. The method of aspect 2, wherein the master cost function is a weighted sum of the one or more bracket cost functions for each of the plurality of brackets.

6. The method of aspect 1, wherein the plurality of positional parameters comprise at least one positional parameter for each of the plurality of brackets that indicate a position of the bracket relative to a tooth of the plurality of teeth on which the bracket is to be arranged.

7. The method of aspect 6, wherein determining the values for the plurality of positional parameters that optimize the master cost function comprises: optimizing the at least one positional parameter for each of the plurality of brackets while enforcing a condition that each of the plurality of brackets is aligned on an archwire plane, and wherein the positional parameters include one or more one or more parameters indicating an orientation of the archwire plane.

8. The method of aspect 1, wherein the positional parameters include one or more facial-lingual offset parameters.

9. The method of aspect 1, wherein the positional parameters include one or more mesial-distal offset parameters.

10. The method of aspect 1, wherein the positional parameters include one or more one or more archwire plane parameters.

11. The method of aspect 1, further comprising, using the at least one processor: receiving user input specifying initial positions of the 3D geometrical models of the plurality of brackets with respect to the one or more 3D geometrical models for the plurality of teeth; and determining an initial value of the master cost function based on values of the plurality of positional parameters indicated by the specified initial positions of the 3D geometrical models of the plurality of brackets.

12. The method of aspect 1, wherein arranging the 3D geometrical models of the plurality of brackets comprises: determining an archwire path based on the determined values of the plurality of parameters; and arranging the 3D geometrical models of the plurality of brackets along the archwire path.

13. The method of aspect 12, wherein determining the archwire path comprises identifying a plurality of control points indicated by the determined values of the plurality of parameters and generating a spline based on the identified plurality of control points.

14. The method of aspect 1, wherein determining the values of the plurality of parameters that optimize the master cost function comprises determining the values of the plurality of parameters that minimize the master cost function.

15. The method of aspect 1, wherein the positional parameters include positional parameters indicative of the position of one or more brackets for an upper arch of the patient and positional parameters indicative of the position of one or more brackets for a lower arch of the patient.

16. The method of aspect 1, further comprising, using the at least one processor, generating modified 3D geometrical models of the plurality of brackets based on relative positions of the arranged 3D geometrical models of the plurality of brackets and the one or more 3D geometrical models for the plurality of teeth.

17. The method of aspect 16, further comprising, using the at least one processor, generating instructions that, when executed by an additive fabrication device, fabricates a plurality of patient brackets according to the modified 3D geometrical models of the plurality of brackets.

18. The method of aspect 17, further comprising fabricating the plurality of patient brackets using the additive fabrication device.

19. The method of aspect 16, further comprising, using the at least one processor, generating a 3D geometrical model of a bonding tray based on the modified 3D geometrical models of the plurality of brackets.

20. The method of aspect 19, further comprising, using the at least one processor, generating instructions that, when executed by an additive fabrication device, fabricates a bonding tray according to the 3D geometrical model of the bonding tray.

21. The method of aspect 20, further comprising fabricating the bonding tray using the additive fabrication device.

22. At least one non-transitory computer readable medium comprising instructions that, when executed by at least one processor, perform a method comprising: obtaining one or more three-dimensional (3D) geometrical models for a plurality of teeth of a patient; obtaining one or more 3D geometrical models for a plurality of brackets to be arranged on respective teeth of the plurality of teeth; determining values for a plurality of positional parameters that optimize a master cost function, wherein the plurality of positional parameters are each indicative of a position of one or more of the plurality of brackets; and arranging the one or more 3D geometrical models of the plurality of brackets relative to the one or more 3D geometrical models for the plurality of teeth according to the determined values of the plurality of positional parameters.

23. The at least one non-transitory computer readable medium of aspect 22, wherein: the master cost function is a function of one or more bracket cost functions for each of the plurality of brackets; and the one or more bracket cost functions for a respective bracket of the plurality of brackets are each a function of one or more of the plurality of positional parameters.

24. The at least one non-transitory computer readable medium of aspect 23, wherein the one or more bracket cost functions for the respective bracket comprise one or more of: an in-out cost function that is a function of the respective bracket's facial-lingual position; a bracket wall thickness cost function that is a function of the respective bracket's facial-lingual position; a bracket boundary cost function that is a function of the respective bracket's mesial-distal position; and a facial axis (FA) point cost function that is a function of the respective bracket's mesial-distal position.

25. The at least one non-transitory computer readable medium of aspect 23, wherein the one or more bracket cost functions for the respective bracket comprise an upper teeth and lower bracket intersection cost function.

26. The at least one non-transitory computer readable medium of aspect 23, wherein the master cost function is a weighted sum of the one or more bracket cost functions for each of the plurality of brackets.

27. The at least one non-transitory computer readable medium of aspect 22, wherein the plurality of positional parameters comprise at least one positional parameter for each of the plurality of brackets that indicate a position of the bracket relative to a tooth of the plurality of teeth on which the bracket is to be arranged.

28. The at least one non-transitory computer readable medium of aspect 27, wherein determining the values for the plurality of positional parameters that optimize the master cost function comprises: optimizing the at least one positional parameter for each of the plurality of brackets while enforcing a condition that each of the plurality of brackets is aligned on an archwire plane, and wherein the positional parameters include one or more one or more parameters indicating an orientation of the archwire plane.

29. The at least one non-transitory computer readable medium of aspect 22, wherein the positional parameters include one or more facial-lingual offset parameters.

30. The at least one non-transitory computer readable medium of aspect 22, wherein the positional parameters include one or more mesial-distal offset parameters.

31. The at least one non-transitory computer readable medium of aspect 22, wherein the positional parameters include one or more one or more archwire plane parameters.

32. The at least one non-transitory computer readable medium of aspect 22, wherein the method further comprises: receiving user input specifying initial positions of the 3D geometrical models of the plurality of brackets with respect to the one or more 3D geometrical models for the plurality of teeth; and determining an initial value of the master cost function based on values of the plurality of positional parameters indicated by the specified initial positions of the 3D geometrical models of the plurality of brackets.

33. The at least one non-transitory computer readable medium of aspect 22, wherein arranging the 3D geometrical models of the plurality of brackets comprises: determining an archwire path based on the determined values of the plurality of parameters; and arranging the 3D geometrical models of the plurality of brackets along the archwire path.

34. The at least one non-transitory computer readable medium of aspect 33, wherein determining the archwire path comprises identifying a plurality of control points indicated by the determined values of the plurality of parameters and generating a spline based on the identified plurality of control points.

35. The at least one non-transitory computer readable medium of aspect 22, wherein determining the values of the plurality of parameters that optimize the master cost function comprises determining the values of the plurality of parameters that minimize the master cost function.

36. The at least one non-transitory computer readable medium of aspect 22, wherein the positional parameters include positional parameters indicative of the position of one or more brackets for an upper arch of the patient and positional parameters indicative of the position of one or more brackets for a lower arch of the patient.

37. The at least one non-transitory computer readable medium of aspect 22, wherein the method further comprises generating modified 3D geometrical models of the plurality of brackets based on relative positions of the arranged 3D geometrical models of the plurality of brackets and the one or more 3D geometrical models for the plurality of teeth.

38. The at least one non-transitory computer readable medium of aspect 37, wherein the method further comprises generating instructions that, when executed by an additive fabrication device, fabricates a plurality of brackets according to the modified 3D geometrical models of the plurality of brackets.

39. The at least one non-transitory computer readable medium of aspect 37, wherein the method further comprises generating a 3D geometrical model of a bonding tray based on the modified 3D geometrical models of the plurality of brackets.

40. The at least one non-transitory computer readable medium of aspect 39, wherein the method further comprises generating instructions that, when executed by an additive fabrication device, fabricates a bonding tray according to the 3D geometrical model of the bonding tray.

41. A system comprising: at least one processor; and at least one non-transitory computer readable medium comprising instructions that, when executed by the at least one processor, perform a method comprising: obtaining one or more three-dimensional (3D) geometrical models for a plurality of teeth of a patient; obtaining one or more 3D geometrical models for a plurality of brackets to be arranged on respective teeth of the plurality of teeth; determining values for a plurality of positional parameters that optimize a master cost function, wherein the plurality of positional parameters are each indicative of a position of one or more of the plurality of brackets; and arranging the one or more 3D geometrical models of the plurality of brackets relative to the one or more 3D geometrical models for the plurality of teeth according to the determined values of the plurality of positional parameters.

42. The system of aspect 41, wherein: the master cost function is a function of one or more bracket cost functions for each of the plurality of brackets; and the one or more bracket cost functions for a respective bracket of the plurality of brackets are each a function of one or more of the plurality of positional parameters.

43. The system of aspect 42, wherein the one or more bracket cost functions for the respective bracket comprise one or more of: an in-out cost function that is a function of the respective bracket's facial-lingual position; a bracket wall thickness cost function that is a function of the respective bracket's facial-lingual position; a bracket boundary cost function that is a function of the respective bracket's mesial-distal position; and a facial axis (FA) point cost function that is a function of the respective bracket's mesial-distal position.

44. The system of aspect 42, wherein the one or more bracket cost functions for the respective bracket comprise an upper teeth and lower bracket intersection cost function.

45. The system of aspect 42, wherein the master cost function is a weighted sum of the one or more bracket cost functions for each of the plurality of brackets.

46. The system of aspect 41, wherein the plurality of positional parameters comprise at least one positional parameter for each of the plurality of brackets that indicate a position of the bracket relative to a tooth of the plurality of teeth on which the bracket is to be arranged.

47. The system of aspect 46, wherein determining the values for the plurality of positional parameters that optimize the master cost function comprises: optimizing the at least one positional parameter for each of the plurality of brackets while enforcing a condition that each of the plurality of brackets is aligned on an archwire plane, and wherein the positional parameters include one or more one or more parameters indicating an orientation of the archwire plane.

48. The system of aspect 41, wherein the positional parameters include one or more facial-lingual offset parameters.

49. The system of aspect 41, wherein the positional parameters include one or more mesial-distal offset parameters.

50. The system of aspect 41, wherein the positional parameters include one or more one or more archwire plane parameters.

51. The system of aspect 41, wherein the method further comprises: receiving user input specifying initial positions of the 3D geometrical models of the plurality of brackets with respect to the one or more 3D geometrical models for the plurality of teeth; and determining an initial value of the master cost function based on values of the plurality of positional parameters indicated by the specified initial positions of the 3D geometrical models of the plurality of brackets.

52. The system of aspect 41, wherein arranging the 3D geometrical models of the plurality of brackets comprises: determining an archwire path based on the determined values of the plurality of parameters; and arranging the 3D geometrical models of the plurality of brackets along the archwire path.

53. The system of aspect 52, wherein determining the archwire path comprises identifying a plurality of control points indicated by the determined values of the plurality of parameters and generating a spline based on the identified plurality of control points.

54. The system of aspect 41, wherein determining the values of the plurality of parameters that optimize the master cost function comprises determining the values of the plurality of parameters that minimize the master cost function.

55. The system of aspect 41, wherein the positional parameters include positional parameters indicative of the position of one or more brackets for an upper arch of the patient and positional parameters indicative of the position of one or more brackets for a lower arch of the patient.

56. The system of aspect 41, wherein the method further comprises generating modified 3D geometrical models of the plurality of brackets based on relative positions of the arranged 3D geometrical models of the plurality of brackets and the one or more 3D geometrical models for the plurality of teeth.

57. The system of aspect 56, wherein the method further comprises generating instructions that, when executed by an additive fabrication device, fabricates a plurality of brackets according to the modified 3D geometrical models of the plurality of brackets.

58. The system of aspect 56, wherein the method further comprises generating a 3D geometrical model of a bonding tray based on the modified 3D geometrical models of the plurality of brackets.

59. The system of aspect 58, wherein the method further comprises generating instructions that, when executed by an additive fabrication device, fabricates a bonding tray according to the 3D geometrical model of the bonding tray.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semi-custom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Various aspects of the present invention may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A computer-implemented method of arranging orthodontic brackets, the method comprising:
using at least one processor:
obtaining one or more three-dimensional (3D) geometrical models for a plurality of teeth of a patient;
obtaining one or more 3D geometrical models for a plurality of brackets to be arranged on respective teeth of the plurality of teeth;
determining values for a plurality of positional parameters that optimize a master cost function, wherein the plurality of positional parameters are each indicative of a position of one or more of the plurality of brackets; and
arranging the one or more 3D geometrical models of the plurality of brackets relative to the one or more 3D geometrical models for the plurality of teeth according to the determined values of the plurality of positional parameters.

2. The method of claim 1, wherein:
the master cost function is a function of one or more bracket cost functions for each of the plurality of brackets; and
the one or more bracket cost functions for a respective bracket of the plurality of brackets are each a function of one or more of the plurality of positional parameters.

3. The method of claim 2, wherein the one or more bracket cost functions for the respective bracket comprise one or more of:
an in-out cost function that is a function of the respective bracket's facial-lingual position;
a bracket wall thickness cost function that is a function of the respective bracket's facial-lingual position;
a bracket boundary cost function that is a function of the respective bracket's mesial-distal position; and
a facial axis (FA) point cost function that is a function of the respective bracket's mesial-distal position.

4. The method of claim 2, wherein the one or more bracket cost functions for the respective bracket comprise an upper teeth and lower bracket intersection cost function.

5. The method of claim 2, wherein the master cost function is a weighted sum of the one or more bracket cost functions for each of the plurality of brackets.

6. The method of claim 1, wherein the plurality of positional parameters comprise at least one positional parameter for each of the plurality of brackets that indicate a position of the bracket relative to a tooth of the plurality of teeth on which the bracket is to be arranged.

7. The method of claim 6, wherein determining the values for the plurality of positional parameters that optimize the master cost function comprises:
optimizing the at least one positional parameter for each of the plurality of brackets while enforcing a condition that each of the plurality of brackets is aligned on an archwire plane, and
wherein the positional parameters include one or more one or more parameters indicating an orientation of the archwire plane.

8. The method of claim 1, wherein the positional parameters include one or more facial-lingual offset parameters.

9. The method of claim 1, wherein the positional parameters include one or more mesial-distal offset parameters.

10. The method of claim 1, wherein the positional parameters include one or more one or more archwire plane parameters.

11. The method of claim 1, further comprising, using the at least one processor:
receiving user input specifying initial positions of the 3D geometrical models of the plurality of brackets with respect to the one or more 3D geometrical models for the plurality of teeth; and
determining an initial value of the master cost function based on values of the plurality of positional parameters indicated by the specified initial positions of the 3D geometrical models of the plurality of brackets.

12. The method of claim 1, wherein arranging the 3D geometrical models of the plurality of brackets comprises:
determining an archwire path based on the determined values of the plurality of parameters; and
arranging the 3D geometrical models of the plurality of brackets along the archwire path.

13. The method of claim 12, wherein determining the archwire path comprises identifying a plurality of control points indicated by the determined values of the plurality of parameters and generating a spline based on the identified plurality of control points.

14. The method of claim 1, wherein determining the values of the plurality of parameters that optimize the master cost function comprises determining the values of the plurality of parameters that minimize the master cost function.

15. The method of claim 1, wherein the positional parameters include positional parameters indicative of the position of one or more brackets for an upper arch of the patient and positional parameters indicative of the position of one or more brackets for a lower arch of the patient.

16. The method of claim 1, further comprising, using the at least one processor, generating modified 3D geometrical models of the plurality of brackets based on relative positions of the arranged 3D geometrical models of the plurality of brackets and the one or more 3D geometrical models for the plurality of teeth.

17. The method of claim 16, further comprising, using the at least one processor, generating instructions that, when executed by an additive fabrication device, fabricates a plurality of patient brackets according to the modified 3D geometrical models of the plurality of brackets.

18. The method of claim 17, further comprising fabricating the plurality of patient brackets using the additive fabrication device.

19. The method of claim 16, further comprising, using the at least one processor, generating a 3D geometrical model of a bonding tray based on the modified 3D geometrical models of the plurality of brackets.

20. The method of claim 19, further comprising, using the at least one processor, generating instructions that, when executed by an additive fabrication device, fabricates a bonding tray according to the 3D geometrical model of the bonding tray.

21. The method of claim 20, further comprising fabricating the bonding tray using the additive fabrication device.

22. At least one non-transitory computer readable medium comprising instructions that, when executed by at least one processor, perform a method comprising:
obtaining one or more three-dimensional (3D) geometrical models for a plurality of teeth of a patient;
obtaining one or more 3D geometrical models for a plurality of brackets to be arranged on respective teeth of the plurality of teeth;
determining values for a plurality of positional parameters that optimize a master cost function, wherein the plurality of positional parameters are each indicative of a position of one or more of the plurality of brackets; and
arranging the one or more 3D geometrical models of the plurality of brackets relative to the one or more 3D geometrical models for the plurality of teeth according to the determined values of the plurality of positional parameters.

23. A system comprising:
at least one processor; and
at least one non-transitory computer readable medium comprising instructions that, when executed by the at least one processor, perform a method comprising:
obtaining one or more three-dimensional (3D) geometrical models for a plurality of teeth of a patient;
obtaining one or more 3D geometrical models for a plurality of brackets to be arranged on respective teeth of the plurality of teeth;
determining values for a plurality of positional parameters that optimize a master cost function, wherein the plurality of positional parameters are each indicative of a position of one or more of the plurality of brackets; and
arranging the one or more 3D geometrical models of the plurality of brackets relative to the one or more 3D geometrical models for the plurality of teeth according to the determined values of the plurality of positional parameters.
